(19) United States
(12) Patent Application Publication
(10) Pub. No.: US 2020/0346244 A1
(43) Pub. Date: Nov. 5, 2020

(54) CAULK GUN

(71) Applicant: TECHTRONIC CORDLESS GP, Anderson, SC (US)

(72) Inventors: Tyler Knight, Greenville, SC (US); Peter J. Roberts, Greenville, SC (US)

(21) Appl. No.: 16/864,602

(22) Filed: May 1, 2020

Related U.S. Application Data
(60) Provisional application No. 62/842,840, filed on May 3, 2019.

(51) Int. Cl. B05C 17/015; B05C 17/005

(52) U.S. Cl. CPC B05C 17/015; B05C 17/00569

(57) ABSTRACT

A caulk gun includes a body, a pump supported on the body, a motor supported by the body to drive the pump, a trigger supported on the body. The body is configured to support a sealant container adjacent the outlet. A force generated by the pressurized air in the fluid passage is configured to be transmitted to a portion of the sealant container. The pump is in fluid communication with the inlet and configured to drive pressurized air through the fluid passage. Actuation of the trigger is configured to actuate the motor. The pressure release mechanism is positioned at least partially within the fluid passage. The pressure release mechanism is moveable between a first position in which pressurized air can be vented from the fluid passage and a second position in which the pressure release mechanism inhibits venting of pressurized air from the fluid passage.

### CROSS-REFERENCE TO RELATED APPLICATION

This application claims the benefit of co-pending U.S. Provisional Patent Application No. 62/842,840, filed May 3, 2019, the entire contents of which are incorporated by reference.

### FIELD

The present disclosure relates to power tools, and particularly to a battery-powered pneumatic caulk gun.

### BACKGROUND

Caulk guns include a body and a container of sealant coupled to the body. A user may actuate a lever to cause sealant to be expelled from the container and onto a worksurface.

### SUMMARY

In one independent aspect, a caulk gun includes a body, a pump supported on the body, a motor supported by the body and configured to drive the pump, a trigger supported on the body, and a pressure release mechanism. The body includes an inlet, an outlet, and a fluid passage in fluid communication with the outlet. The body is configured to support a sealant container adjacent the outlet. A force generated by the pressurized air in the fluid passage is configured to be transmitted to a portion of the sealant container. The pump is in fluid communication with the inlet and configured to drive pressurized air through the fluid passage. Actuation of the trigger is configured to actuate the motor. The pressure release mechanism is positioned at least partially within the fluid passage. The pressure release mechanism is moveable between a first position in which pressurized air can be vented from the fluid passage and a second position in which the pressure release mechanism inhibits venting of pressurized air from the fluid passage.

In another independent aspect, a pneumatic caulk gun includes a body, a pump supported on the body, and an electric motor supported by the body and configured to drive the pump. The body includes an inlet, an outlet, and a fluid passage in fluid communication with the outlet, and the body is configured to support a sealant container adjacent the outlet. A force generated by the pressurized air in the fluid passage is configured to be transmitted to a portion of the sealant container. The fluid passage includes a port for exhausting pressurized air to an external environment. The pump is in fluid communication with the inlet and is configured to drive pressurized air through the fluid passage. The motor has a shaft axis oriented orthogonal with respect to the outlet such that a small dimension of the motor extends along a width of the body.

In yet another independent aspect, a pneumatic caulk gun includes a body, a fluid passage disposed within the body, a pump supported on the body, and a pressure release mechanism. The body includes an inlet and an outlet, and the body is configured to support a sealant container adjacent the outlet. The fluid passage is in fluid communication with the outlet such that pressurized air in the fluid passage is capable of exerting a force on the container of sealant. The fluid passage includes a port for exhausting pressurized air to an external environment. The pump is in fluid communication with the inlet and configured to drive pressurized air through the fluid passage. The pressure release mechanism is supported for movement within the fluid passage for selectively blocking air flow through the port.

Other aspects of the disclosure will become apparent by consideration of the detailed description and accompanying drawings.

### BRIEF DESCRIPTION OF THE DRAWINGS

FIG. 1 is a perspective view of a caulk gun.

FIG. 2 is perspective view of the caulk gun in FIG. 1 with a tube in a disassembled state.

FIG. 3 is a cross-sectional view of the caulk gun of FIG. 1, viewed along section 3-3, with a container positioned in the tube.

FIG. 4 is a detail view of a portion of the caulk gun of FIG. 3.

FIG. 5 is a perspective view of a caulk gun according to another embodiment.

FIG. 6 is a detail view of a portion of a caulk gun according to another embodiment.

Before any embodiments of the disclosure are explained in detail, it is to be understood that the disclosure is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### DETAILED DESCRIPTION

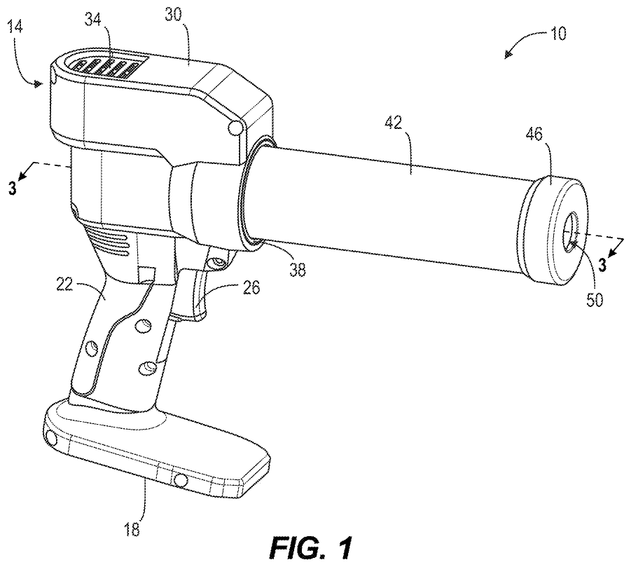

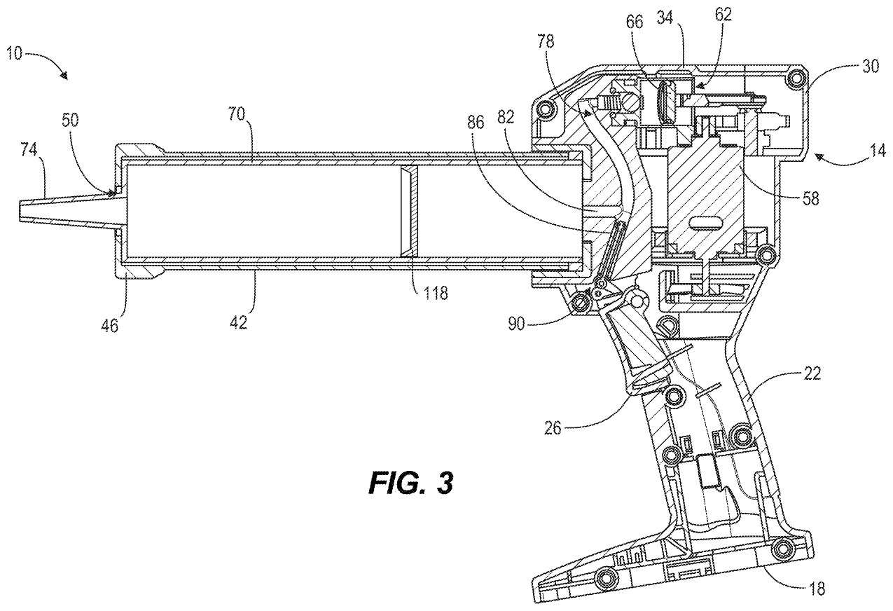

FIGS. 1-4 illustrate a caulk gun 10. As shown in the illustrated embodiment, the caulk gun 10 is a battery-powered, pneumatic caulk gun 10 in which pressurized air is used to expel caulk from a container 70 (FIG. 3) supported on the caulk gun 10.

As shown in FIG. 1, the caulk gun 10 includes a main body 14 with a battery receptacle 18. The receptacle 18 may be positioned at a base of the caulk gun 10 and may be configured to receive a battery (e.g., a power tool battery pack—not shown). The receptacle 18 may include an attachment mechanism (e.g., actuating latches—not shown) to removably couple the battery to the receptacle 18. In some embodiments, the battery may be an 18 V battery.

The main body 14 also includes a grip 22 disposed adjacent the receptacle 18. The grip 22 may be sized to approximately correspond to an average user's hand. For example, a perimeter of the grip 22 may be substantially the same as a length of a user's hand. A trigger 26 is positioned adjacent the grip 22, and distal to the receptacle 18. The trigger 26 may be moveable with respect to the grip 22. In some embodiments, the grip 22 may be at least partially formed from an elastomeric material (e.g., rubber). The elastomeric material may assist the user in maintaining a firm grasp on the grip 22. In some embodiments, a trigger lock (not shown) may be coupled to the grip 22 and be moveable with respect to the grip 22 between an unlocked position and a locked position in which the trigger lock prevents actuation of the trigger 26.

The main body 14 further includes an upper housing 30 disposed adjacent the grip 22 (e.g., the grip 22 is disposed between the receptacle 18 and the upper housing 30). The upper housing 30 includes an inlet 34 and an outlet 38. In the illustrated embodiment, the inlet 34 is a grated or louvered opening positioned on an opposite end of the main body 14 relative to the receptacle 18 (e.g., on an upper surface of the main body 14). Also, in the illustrated embodiment, the outlet 38 is disposed on a different surface of the main body 14 from the inlet 34 (e.g., on a surface oriented approximately 90° with respect to the inlet 34). The inlet 34 and the outlet 38 provide fluid communication into and out of the upper housing 30. In the illustrated embodiment, the outlet 38 may be circular. In other embodiments, the outlet 38 may include different shapes (e.g., elliptical, triangular, rectangular, etc.).

With continued reference to FIG. 1, the caulk gun 10 also includes a tube 42 that may be coupled to the outlet 38 of the upper housing 30. A cap 46 may be coupled to one end of the tube 42 (e.g., an end distal from the upper housing 30). The cap 46 may include an aperture 50 (e.g., a circular aperture). In the illustrated embodiment, a diameter of the aperture 50 may be less than a diameter of the tube 42. The diameter of the tube 42 may also be less than a diameter of the outlet 38, so that the tube 42 may fit within the outlet 38.

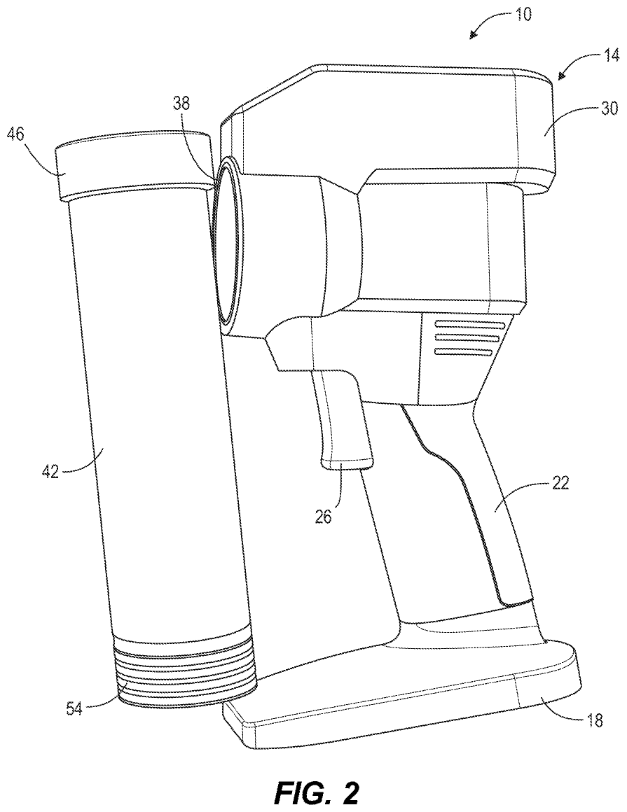

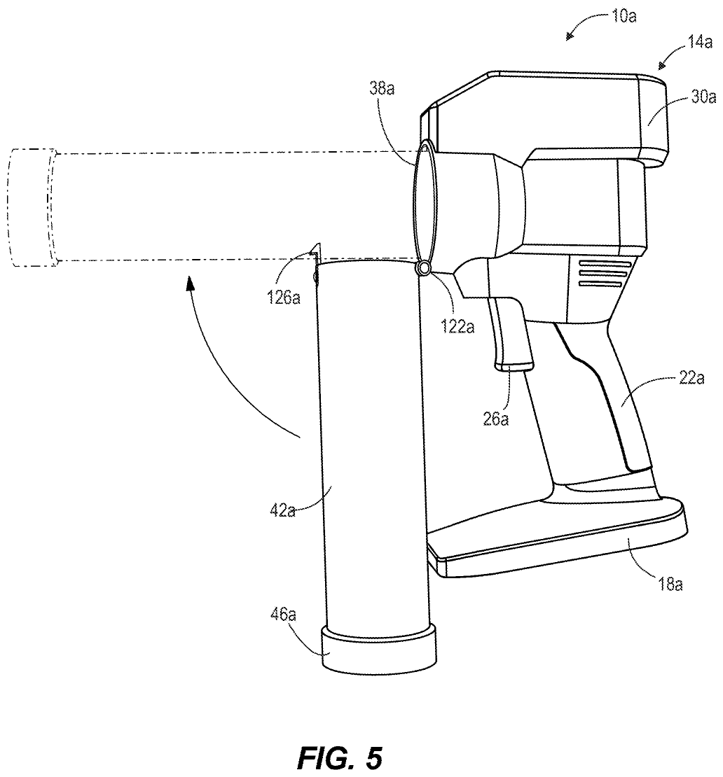

As shown in FIG. 2, the tube 42 may be removable (e.g., partially removable, fully removable, and/or the like) from the main body 14. In some embodiments, the tube 42 may fold or pivot relative to the main body 14 (FIG. 5). In the illustrated embodiment, the tube 42 may include threads 54, and the outlet 38 may include corresponding threads (not shown). The tube 42 may be uncoupled from the main body 14 by unthreading the tube 42 from the main body 14. In other embodiments, the tube 42 may be removably coupled to the main body 14 in another manner (e.g., with a press fit, a snap-fit, and/or the like). Removing the tube 42 from the main body 14 may create a smaller footprint, so that the caulk gun 10 can be more easily packaged and/or stored. An overall width and depth of the caulk gun 10 may be less than existing caulk guns (not shown), which may further contribute to the small footprint of the caulk gun 10.

As shown in FIG. 3, a motor 58 may be positioned within the upper housing 30. The motor 58 is electrically coupled to the battery via the trigger 26 (e.g., actuation of the trigger 26 provides electrical communication between the motor 58 and the battery). In the illustrated embodiment, a rotational shaft axis 60 of the motor 58 is oriented in a direction generally orthogonal with respect to the outlet 38, and a narrow dimension of the motor 58 extends along the width of the upper housing 30. This allows the upper housing 30 to maintain a narrow profile conducive to being easily packaged and/or stored. In some embodiments, the motor 58 may include an alternating current (AC) induction motor, which may use electromagnetic induction to generate a torque. In other embodiments, a different type of motor may be used (e.g., a direct current (DC) motor, and/or the like).

A pump 62 (e.g., a pneumatic pump or compressor) may be positioned within the upper housing 30. The pump 62 may be coupled to the motor 58 so that actuation of the motor 58 causes actuation of the pump 62. In the illustrated embodiment, the pump 62 includes a single piston 66. In other embodiments, the pump 62 may be another type of pump. For example, and as persons skilled in the art shall appreciate, multiple piston pumps 62 are also contemplated. The pump 62 may be positioned proximate the inlet 34 and may be configured to draw air in through the inlet 34 from an external environment.

The tube 42 may be hollow and may receive a container 70. A nozzle 74 may be coupled to one end of the container 70, and a total length of the container 70 and nozzle 74 may be longer than a total length of the tube 42. The nozzle 74 may include a diameter less than the diameter of the aperture 50 of the tube 42, and the nozzle 74 may protrude beyond the aperture 50. In the illustrated embodiment, the container 70 includes caulk or another type of sealant. In some embodiments, the container 70 may be inserted into the tube 42 while the tube 42 is separated from the main body 14. Then the tube 42 is coupled to the main body 14 (e.g., via the threads 54). In some embodiments, the container 70 may be positioned within the tube 42 while the tube 42 is secured to the main body 14. For example, the cap 46 may be removably coupled to the tube 42 (e.g., via threads, a press fit, etc.), and the cap 46 may be uncoupled from the distal end of the tube 42 in order to allow the container to be positioned within the tube 42.

A fluid passage 78 provides fluid communication between the pump 62 and the outlet 38. In the illustrated embodiment, the fluid passage 78 may include a first branch 82 and a second branch 86. The first branch 82 may extend toward the outlet 38. The second branch 86 provides a port through which pressurized air may be exhausted or vented from the fluid passage. In the illustrated embodiment, the second branch 86 may extend toward the trigger 26.

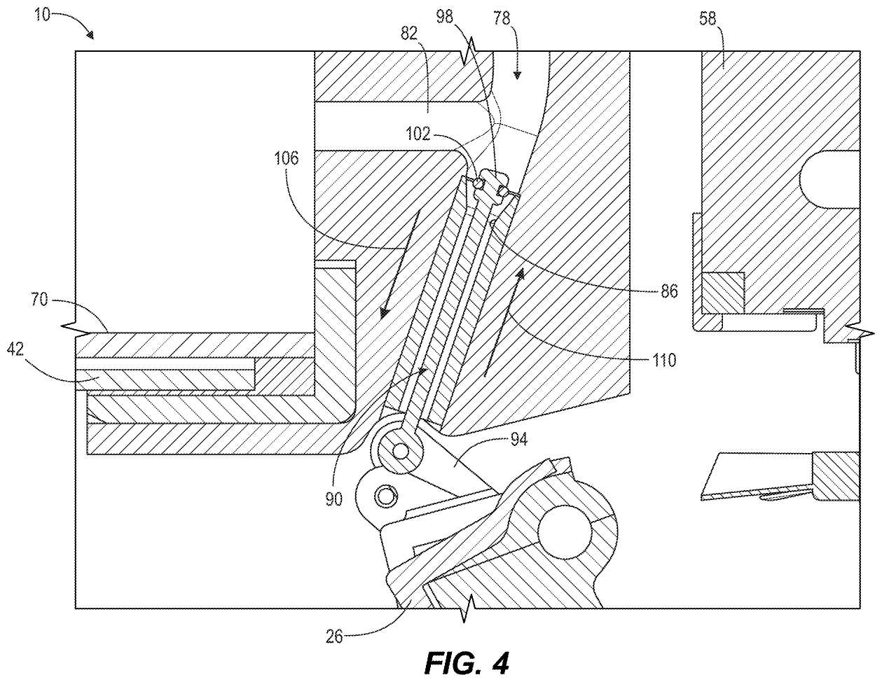

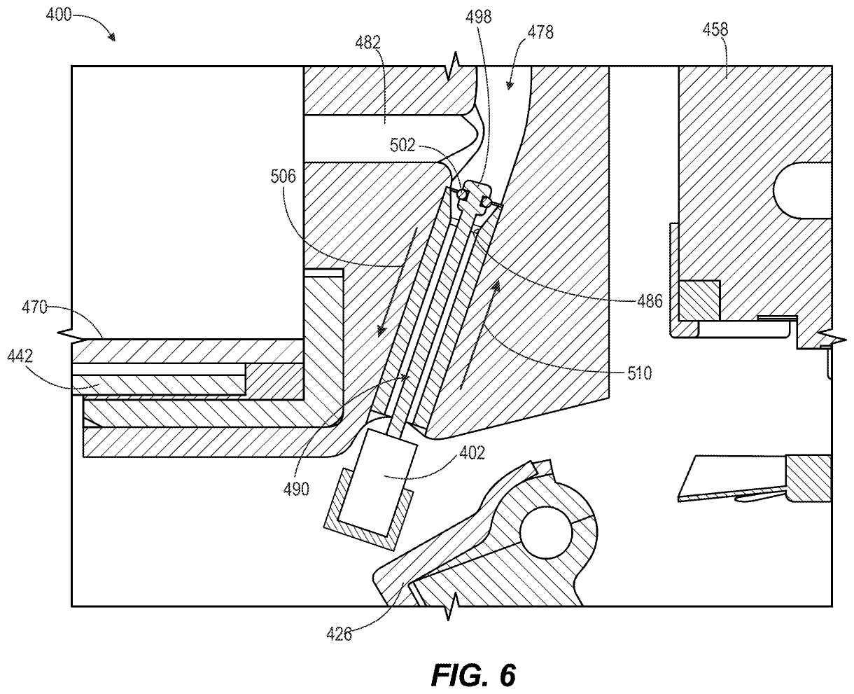

As shown in FIG. 4, a pressure release mechanism 90 (e.g., a plunger) is positioned within the second branch 86. The pressure release mechanism 90 may include an elongated body that extends substantially along a length of the second branch 86. One end of the pressure release mechanism 90 may be coupled to the trigger 26 (e.g., via a link 94), so that the pressure release mechanism 90 may move with the trigger 26. An opposite end of the pressure release mechanism 90 may include a stopper 98. The pressure release mechanism 90 may be in a first or unsealed position (illustrated in FIG. 4) while the trigger 26 is not actuated. In the illustrated embodiment, a seal, or a sealing member (e.g., an O-ring 102), may be positioned around a perimeter of the stopper 98. A diameter of the O-ring 102 may be greater than an operating diameter of the second branch 86. In other embodiments, the pressure release mechanism 90 may be coupled to an independent actuator (e.g. an electronic solenoid—FIG. 6) separate from the trigger 26.

During operation, a container 70 may be positioned within the tube 42 (e.g., by one of the two methods described above). Once the tube 42 and container 70 are coupled to the main body 14, the user may actuate the trigger 26 to expel sealant from the container 70. Movement of the trigger 26 causes the link 94 to move, which in turn causes the pressure release mechanism 90 to seal the second branch 86. In the illustrated embodiment, actuation of the trigger 26 causes the pressure release mechanism 90 is moved in a first direction 106 along the second branch 86 (e.g., toward the trigger 26). The pressure release mechanism 90 may continue to move until the O-ring 102 is seated within an opening of the second branch 86 and the pressure release mechanism 90 is in a second or sealed position. In this position, fluid flow through the second branch 86 is blocked by the O-ring 102. In other words, the O-ring 102 seals the fluid passage 78 from the external environment while the O-ring 102 is seated at the opening of the second branch 86. The O-ring also provides a seal between the external environment and an end of the container 70 distal to the nozzle 74.

In the illustrated embodiment, the motor 58 may remain off during an initial stage of movement by the pressure release mechanism 90 in the first direction 106. The motor 58 turns on as the user continues to apply pressure to the trigger 26, after the O-ring 102 seals the second branch 86 (e.g., the trigger 26 may contact a motor switch and complete the circuit between the battery and the motor 58). The motor 58 may activate the pump 62 to drive air from the external environment into the fluid passage 78. The air flow may be directed into the first branch 82 as the O-ring 102 blocks air flow through the second branch 86.

While the pressure release mechanism 90 is in the sealed position and the pump 62 is activated, the fluid passage 78 is pressurized. Pressurized air from the pump 62 may be unable to escape to the external environment and may travel through the first branch 82 to exert a fluid force against an end cap or tube piston 118 of the container 70. The force drives the tube piston 118 of the container 70 toward the nozzle 74, thereby compressing the volume in the container 70 and causing sealant to be expelled through the nozzle 74. In some embodiments, the amount of sealant flowing through the nozzle 74 is proportional to the flow rate of the pump 62 and the pressure of the air.

When the trigger 26 is released, the steps to pressurize the fluid passage 78 may occur in reverse. The motor 58 may no longer be in electrical communication with the battery and turns off. The pump 62 may also deactivate once the motor 58 is no longer in electrical communication with the battery. Pressurized air stops flowing from the pump 62, but the fluid passage 78 may remain pressurized. As the user continues to release the trigger 26, the pressure release mechanism 90 moves in a second direction 110 opposite the first direction 106 and returns to the unsealed position. The O-ring 102 may move out of the opening of the second branch 86 (e.g., toward the first branch 82). The second branch 86 may taper or flare and become wider in the second direction so that the O-ring is not wide enough to seal the second branch 86 when the trigger 26 is fully released. This exposes a fluid path between the fluid passage 78 and the external environment, permitting the pressurized air that remains in the fluid passage 78 to escape and thereby depressurizing the fluid passage 78. In some embodiments, the flow of sealant through the nozzle 74 stops once the force exerted on the tube piston 118 is no longer sufficient to move the piston 118 toward the nozzle 74. The flow of sealant through the nozzle 74 may stop once the pressure in the fluid passage 78 reaches ambient pressure.

In some embodiments, such as the caulk gun 10a shown in FIG. 5, the tube 42a is pivotably with respect to the body 14a. The tube 42a doesn't include threads and is pivotably attached to the outlet 38a by a hinge 122a. The hinge 122a allows the tube 42a to move between a first position (shown in dashed line) and a second position (as illustrated in FIG. 5). The tube 42a is retained in the first position by a retaining member 126a. The retaining member is shown as a resilient latch in the illustrated embodiment but could also be any of various other types of retaining devices.

FIG. 6 illustrates a caulk gun 400 according to another embodiment. Many features of the caulk gun 400 are similar to the caulk gun 10, and similar features are identified by similar reference numbers, plus 400. Some differing aspects of the caulk gun 400 are described in detail for the sake of brevity. The caulk gun 400 includes a pressure release mechanism 490 including an electric solenoid 402. The solenoid 402 is operable based on actuation of the trigger 426, and operation of the solenoid moves the pressure release mechanism 490 along the second branch 486 in order to selectively seal the fluid passageway 478 from the external environment. In some embodiments, activation or deactivation of the solenoid 402 can be delayed in response to activation or deactivation of the trigger 426, as described above.

Although aspects have been described in detail with reference to certain embodiments, variations and modifications exist within the scope of one or more independent aspects as described. Various features of the disclosure are set forth in the following claims.

What is claimed is:

1. A caulk gun comprising:
a body including an inlet, an outlet, and a fluid passage in fluid communication with the outlet, the body configured to support a sealant container adjacent the outlet, a force generated by the pressurized air in the fluid passage configured to be transmitted to a portion of the sealant container;
a pump supported on the body, the pump in fluid communication with the inlet and configured to drive pressurized air through the fluid passage;
a motor supported by the body and configured to drive the pump;
a trigger supported on the body, actuation of the trigger configured to actuate the motor; and
a pressure release mechanism positioned at least partially within the fluid passage, the pressure release mechanism being moveable between a first position, in which pressurized air can be vented from the fluid passage, and a second position in which the pressure release mechanism inhibits venting of pressurized air from the fluid passage.

2. The caulk gun of claim 1, wherein the body further includes a receptacle configured to removable receive a battery for providing power to the motor.

3. The caulk gun of claim 1, further comprising a tube removably coupled to the body proximate the outlet, the tube being configured to support the sealant container, and an end of the tube being in fluid communication with the fluid passage.

4. The caulk gun of claim 1, wherein the pressure release mechanism includes a stopper and a sealing member supported on the stopper, wherein the sealing member seals a portion of the fluid passage while the pressure release mechanism is in the second position.

5. The caulk gun of claim 1, wherein actuation of the trigger causes the pressure release mechanism to move toward the second position, and wherein the motor is actuated after the pressure release mechanism is positioned in the second position.

6. The caulk gun of claim 1, wherein the fluid passage includes a first portion that extends to the outlet and a second portion that extends toward the trigger, and wherein the pressure release mechanism blocks airflow through the second portion in the second position.

7. A pneumatic caulk gun comprising:
a body including an inlet, an outlet, and a fluid passage in fluid communication with the outlet, the body configured to support a sealant container adjacent the outlet, a force generated by the pressurized air in the fluid passage configured to be transmitted to a portion of the sealant container, the fluid passage including a port for exhausting pressurized air to an external environment;
a pump supported on the body, the pump in fluid communication with the inlet and configured to drive pressurized air through the fluid passage; and
an electric motor supported by the body and configured to drive the pump, the motor having a shaft axis oriented orthogonal with respect to the outlet such that a small dimension of the motor extends along a width of the body.

8. The pneumatic caulk gun of claim 7, further comprising a tube removably coupled to the outlet and configured to support a container of sealant.

9. The pneumatic caulk gun of claim 7, further comprising a pressure release mechanism positioned at least partially within the fluid passage, the pressure release mechanism moveable between a first position in which pressurized air can be vented from the fluid passage through the port and a second position in which the pressure release mechanism inhibits venting of pressurized air through the port.

10. The pneumatic caulk gun of claim 9, further comprising a trigger supported on the body, wherein actuation of the trigger causes the pressure release mechanism to move toward the second position, wherein the pump is actuatable to provide pressurized air to the fluid passage when the pressure release mechanism is positioned to block air flow through the port.

11. A pneumatic caulk gun comprising:
a body including an inlet and an outlet, the body configured to support a sealant container adjacent the outlet;
a fluid passage disposed within the body, the fluid passage in fluid communication with the outlet such that pressurized air in the fluid passage is capable of exerting a force on the container of sealant, the fluid passage including a port for exhausting pressurized air to an external environment;
a pump supported on the body, the pump in fluid communication with the inlet and configured to drive pressurized air through the fluid passage; and
a pressure release mechanism supported for movement within the fluid passage for selectively blocking air flow through the port.

12. The pneumatic caulk gun of claim 11, wherein a trigger is coupled to the body and configured to selectively actuate the pump, wherein movement of the trigger causes movement of the pressure release mechanism.

13. The pneumatic caulk gun of claim 11, further comprising a motor supported on the body, the motor configured to be selectively powered by a battery to drive the pump.

14. The pneumatic caulk gun of claim 11, wherein the pressure release mechanism includes a stopper and an O-ring supported on the stopper to selectively seal the port.

15. The pneumatic caulk gun of claim 11, wherein the pump is actuatable to provide pressurized air to the fluid passage when the pressure release mechanism is positioned to block air flow through the port.

16. The pneumatic caulk gun of claim 11, wherein the pump is a single piston air pump.

17. The pneumatic caulk gun of claim 11, further comprising a tube removably coupled to the body proximate the outlet and configured to support the sealant container, an end of the tube being in fluid communication with the fluid passage.

18. The pneumatic caulk gun of claim 17, wherein a cap is coupled to a distal end of the tube, the cap including an aperture configured to receive a nozzle of the sealant container.

19. The pneumatic caulk gun of claim 17, wherein the tube is pivotably connected to the body.

20. The pneumatic caulk gun of claim 11, wherein the pressure release mechanism is actuated by an electric solenoid.
